(19) United States
(12) Patent Application Publication
(10) Pub. No.: US 2023/0381837 A1
(43) Pub. Date: Nov. 30, 2023

(54) GLASS SHEET CLEANING APPARATUS

(71) Applicant: CORNING INCORPORATED, Corming, NY (US)

(72) Inventors: Yunho Jung, Cheonan-si (KR); Sangmo Kim, Cheonan-si (KR); Jun-uk Park, Cheonan-si (KR); Young-Choon Song, Asan-si (KR)

(21) Appl. No.: 18/034,231

(22) PCT Filed: Nov. 1, 2021
(86) PCT No.: PCT/US2021/057565

§ 371 Date: Apr. 27, 2023

(30) Foreign Application Priority Data
Nov. 3, 2020 (KR) 10-2020-0145320

(51) Int. Cl. B08B 11/04; B08B 1/00; B08B 1/02; A46B 13/00; A46B 13/02; A46B 5/00; C03C 23/00

(52) U.S. Cl. CPC B08B 11/04; B08B 1/002; B08B 1/02; A46B 13/008; A46B 13/02; A46B 5/0087; C03C 23/0075; A46B 2200/3073

(57) ABSTRACT

A glass cleaning apparatus including a brush head rotatable about an axis of rotation, the brush head having a drive portion slidably coupled to a drive shaft and a brush portion tiltably coupled to the drive portion.

### CROSS-REFERENCE TO RELATED APPLICATIONS

This application claims the benefit of priority under 35 U.S.C. § 119 of Korean Patent Application Serial No. 10-2020-0145320 filed on Nov. 3, 2020 the content of which is relied upon and incorporated herein by reference in its entirety.

### FIELD

The present disclosure relates to an apparatus for cleaning a glass sheet as the glass sheet is conveyed along a conveyance path, and more particularly to brush heads including a brush portion movably coupled to a drive portion allowing the brush portion to rotate, e.g., tilt, in relation to the drive portion.

### BACKGROUND

It is known to wash glass sheets prior to using the glass sheet in a subsequent manufacturing process. Such washing can occur at the point of origin (the glass manufacturer), or at a remote location (e.g., a purchaser and/or user of the glass sheet). Typically, brushes used in a washing operation contact a major surface of the glass sheet. These brushes are connected directly to a drive shaft and must be aligned, and maintained in alignment, to provide effective contact with the glass surface. Measurements have shown that alignment of such brushes can be poor. However, the brush realignment process is time and labor intensive, particularly for installations using large numbers of brushes.

Accordingly, a system capable of rapid alignment of the brush heads relative to the glass surface can save time and money and can improve the effectiveness of the glass cleaning process.

### SUMMARY

To produce repeatable, effective cleaning of glass sheet surfaces, a cleaning apparatus is disclosed wherein a major surface of the glass sheet is contacted by a plurality of rotatably-mounted brushes. The brushes utilize gravity to self-align to the glass surface, ensuring proper contact between the brush head and the glass surface and effective cleaning of the glass surface.

Accordingly, a glass cleaning apparatus is disclosed, comprising a brush head rotatable about an axis of rotation and comprising a drive portion slidably coupled to a drive shaft and a brush portion rotatably coupled to the drive portion. The drive portion defines a bore extending along the axis of rotation. The drive portion further comprises a shaft extension coupled to the drive shaft and movably captured in the bore. In various embodiments, the drive portion further comprises a key extending into the bore and slidably engaged with a keyway in the shaft extension.

In various embodiments, the drive portion comprises a socket disposed therein, and the brush portion comprises a ball extending therefrom and rotatably engaged in the socket.

In some embodiments, the brush portion can comprise one or more torque transfer members extending therefrom, the torque transfer members spaced radially from the axis of rotation and slidably engaged with respective recesses in the drive portion.

In some embodiments, the glass cleaning apparatus can comprise a plurality of brush heads arranged in a first row, for example a linear row extending in a width-wise direction across a conveyed glass sheet. In some embodiments, the glass cleaning apparatus can comprise a second row of brush heads. The brush portion is provided with a brush.

In other embodiments, a glass cleaning apparatus is described, comprising a glass sheet conveyance apparatus configured to convey a glass sheet through the glass cleaning apparatus. The glass cleaning apparatus may further comprise a cleaning fluid dispensing system. The glass cleaning apparatus may still further comprise a scrubbing apparatus comprising a brush head including a drive portion rotatable about an axis of rotation and slidably coupled to a drive shaft, and a brush portion rotatably coupled to the drive portion. The drive portion defines a bore extending along the axis of rotation. The drive portion further comprises a shaft extension coupled to the drive shaft and movably captured in the bore. The drive portion may comprise a key extending into the bore and slidably engaged with a keyway in the shaft extension. The drive portion may still further comprise a socket disposed therein, wherein the brush portion comprises a ball extending therefrom and rotatably engaged in the socket.

In some embodiments, the brush portion can comprise one or more torque transfer members extending therefrom, the torque transfer members spaced radially from the axis of rotation and slidably engaged with a recess in the drive portion.

In some embodiments, the glass cleaning apparatus can comprise a plurality of brush heads.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of a glass cleaning apparatus according to an embodiment of the present disclosure;

FIG. 2 is a plan view of an arrangement of rows of brush heads on a glass sheet;

FIG. 3 is a cross-sectional side view of an exemplary brush head;

FIG. 4 is a perspective view, exploded, of a drive portion of the brush head of FIG. 3;

FIG. 5 is a plan view of a bottom surface of the drive portion of FIG. 4;

FIG. 6 is a detailed view of a ball joint joining the drive portion and the brush portion of the brush head of FIG. 3;

FIG. 7 is a cross-sectional side view, partially exploded, of the brush portion of the brush head of FIG. 3;

FIG. 8 is a schematic view of an exemplary brush head according to embodiments of the present disclosure illustrating tilting movement between the drive portion and the brush portion of the brush head.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic with respect to arrangement of steps, operational flow, order of components, or orientation of components, plain meaning derived from grammatical organization or punctuation, and the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

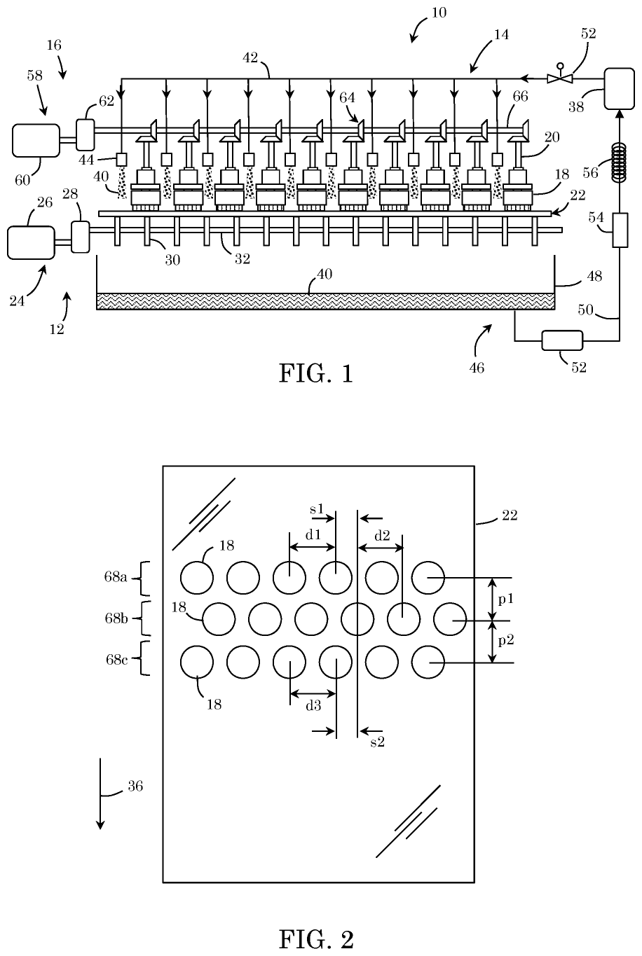

Shown in FIG. 1 is an exemplary glass cleaning apparatus 10 comprising a conveyance apparatus 12, a cleaning fluid dispensing system 14, and a scrubbing apparatus 16 comprising a plurality of brush heads 18 coupled to respective first drive shafts 20. Conveyance apparatus 12 is configured to convey glass substrate 22 through glass cleaning apparatus 10 and can include a drive assembly 24 comprising a first drive motor 26, a first gear assembly 28 and a plurality of rollers 30 coupled to a second drive shaft 32. Second drive shaft 32 is coupled to first gear assembly 28, which in turn is coupled to first drive motor 26. Rollers 30 move glass sheet 22 along a conveyance path in a conveyance direction 36 (see. FIG. 2). The conveyance path may be a horizontal conveyance path, although in further embodiments, the conveyance path can be angled relative to horizontal.

As further shown in FIG. 1, cleaning fluid dispensing system 14 includes a cleaning fluid source 38 for cleaning fluid 40, e.g., a liquid cleaning fluid such as water or a detergent solution (e.g., an aqueous detergent solution), and cleaning fluid delivery piping 42 configured to deliver cleaning fluid 40 to a plurality of cleaning fluid dispensing nozzles 44 from which the cleaning fluid is expelled as a spray onto glass sheet 22. Cleaning fluid source 38 can be any suitable container configured to hold a quantity of cleaning fluid. Cleaning fluid dispensing system 14 may further comprise a cleaning fluid collection apparatus 46, including for example collection container 48 arranged below glass sheet 22, e.g., below rollers 30, and configured to collect cleaning fluid 40 dispensed by cleaning fluid dispensing nozzles 44. In some embodiments, cleaning fluid dispensing system 14 may further include return piping 50 configured to return the dispensed cleaning fluid 40 from collection container 48 to the cleaning fluid source 38. Cleaning fluid delivery and/or return piping 42, 50 may further include one or more cut-off and/or isolation valves 52. In some embodiments, delivery and/or return piping 42, 50 may include a pump 53, a filter 54, and/or a heater 56 for heating cleaning fluid 40 to a predetermined temperature, if needed.

Still referring to FIG. 1, scrubbing apparatus 16 can comprise a second drive apparatus 58 comprising a second drive motor 60, a second drive gear assembly 62, and a third drive gear assembly 64. Second drive motor 60 is coupled to second drive gear assembly 62, which in turn is coupled to third drive gear assembly 64 by third drive shaft 66. Second drive gear assembly 62 can be a reduction gear assembly, wherein the high rotational speed of second drive motor 60 is reduced to a slower rotational speed at third drive shaft 66. Additionally, third drive gear assembly 64 couples third drive shaft 66 to first drive shaft 20, wherein first drive shaft 20 is coupled to a brush head 18. Third drive gear assembly 64 can be configured to change a direction of the torque applied by second drive motor 60 to third drive shaft 66. For example, in some embodiments, third drive shaft 66 can be arranged in a horizontal orientation while first drive shaft 20 is arranged in a vertical orientation. In some embodiments, scrubbing apparatus 16 can comprise a plurality of brush heads 18, a plurality of first drive shafts 20, and a plurality of third drive gear assemblies 64, each brush head 18 of the plurality of brush heads coupled to third drive shaft 66 by a respective third drive gear assembly 64 and a respective first drive shaft 20. The plurality of brush heads 18 may be arranged linearly, for example in a row. Moreover, glass cleaning apparatus 10 can comprise multiple rows of brush heads 18. That is, scrubbing apparatus 16 can comprise a plurality of second drive apparatus 58. In various embodiments, each row of brush heads 18 can be driven by a different second drive apparatus 58. In some embodiments, brush heads 18 of one row of brush heads 18 can be offset from another row of brush heads 18, for example an adjacent row of brush heads, to ensure more complete coverage of the glass sheet surface as the glass sheet passes through glass sheet cleaning apparatus 10. In the embodiment of FIG. 2, three rows 68a, 68b, and 68c of brush heads 18 are illustrated. A distance d1 (center-to-center) between adjacent brush heads of row 68a can be equal to the distance d2 (center-to-center) between adjacent brush heads of row 68b. Similarly, a distance d3 (center-to-center) between adjacent brush heads of row 68c can be equal to the distance d2 and/or d1. In addition, an offset distance s1 (measured between respective centers) between first row 68a of brush heads 18 and second row 68b of brush heads 18 can be 0.5×d1. Similarly, an offset distance s2 between second row 68b of brush heads and third row 68c of brush heads 18 can be 0.5×d2. FIG. 2 further shows that first row 68a of brush heads 18 is separated by a distance p1 (center-to-center) and second row 68b of brush heads 18 is separated from third row 68c of brush heads 18 by a second distance p2 (center-to-center). In embodiments, p1 can be equal to p2, although in further embodiments, p1 can be different than p2. While FIG. 2 depicts three rows of brush heads 18, there can be fewer than three rows or more than three rows of brush heads 18. For example, in some embodiments there may be only a single row of brush heads 18, or two rows of brush heads 18, or four rows of brush heads 18, or more than four rows of brush heads 18.

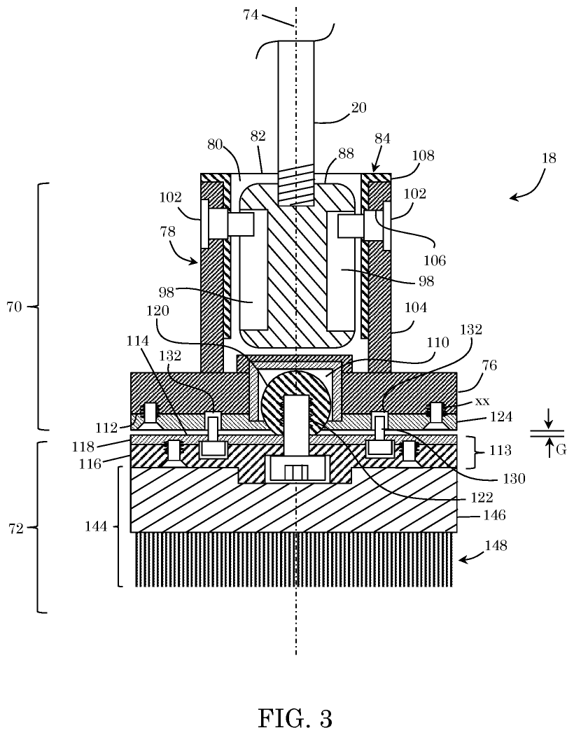

FIG. 3 is a cross-sectional side view of an exemplary brush head 18 comprising a drive portion 70 and a brush portion 72 coupled thereto. Drive portion 70 is rotatable about axis of rotation 74. As shown, drive portion 70 comprises a drive base 76 and a drive collar 78 extending outward from the drive base. Drive collar 78 defines a bore 80 extending longitudinally in drive collar 78 (i.e., parallel with axis of rotation 74), bore 80 comprising an opening 82 at a first end 84 of the drive collar. Drive portion 70 can be slidably engaged with a shaft extension 88 coupled to first drive shaft 20 as will be described below. In some embodiments, at least a portion of bore 80 may include a friction-reducing lining 108, for example a polymer lining (e.g., Teflon, Nylon, etc.), that provides lubricity and prevents shaft extension 88 from binding in bore 80.

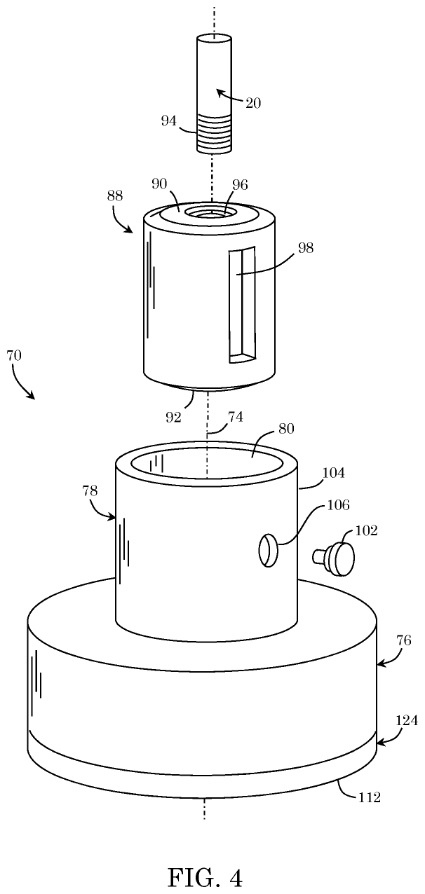

Referring to FIG. 4 showing a perspective, exploded view of drive portion 70, shaft extension 88 comprises a first end 90 and a second end 92 opposite first end 90. In some embodiments, shaft extension 88 may have a generally cylindrical cross-sectional shape between first end 90 and second end 92 in a plane orthogonal to axis of rotation 74. First drive shaft 20 can be coupled to shaft extension 88 via a threaded distal end 94 of first drive shaft 20 that engages with a threaded passage 96 in first end 90 of shaft extension 88. However, other means of coupling shaft extension 88 to first drive shaft 20 as are known in the art can be used.

Shaft extension 88 may further include a keyway 98 extending longitudinally along at least a portion of a length of shaft extension 88 (in a direction parallel with axis of rotation 86). A key 102 extends into bore 80 and slidably engages with keyway 98. Thus, shaft extension 88 is slidable in bore 80 in a direction parallel with axis of rotation 74 (axial translation) but is captured in bore 80 by key 102. The distance shaft extension 88 can slide relative to drive collar 78 is a function of the length of keyway 98 and the size (e.g., length or diameter depending on style) of key 102. In some embodiments, more than one keyway 98 and one key 102 may be employed. For example, shaft extension 88 may include a plurality of keyways 98, such as a pair of keyways 98, three keyways 98, or four or more keyways 98, each keyway engaged with a corresponding key 102. In some embodiments, key 102 may comprise a pin or other member, for example a cylindrical or other shape member inserted through a wall 104 of drive collar 78 such that key 102 extends into bore 80 and engages with keyway 98. Key 102 may, in some embodiments, be removably attached to drive collar 78, such as threaded into a complementarily passage 106 in drive collar 78 (e.g., a threaded passage 106), although other methods of attachment as are known in the art may be used. For example, in some embodiments, key 102 may be pressed into an unthreaded passage 106 utilizing a friction fit. Key 102 transfers torque from first drive shaft 20 (and shaft extension 88) to drive portion 70 such that rotation of first drive shaft 20 produces a rotation of drive portion 70.

Returning to FIG. 3, drive portion 70 defines a socket 110 disposed opposite bore 80. For example, as shown, drive portion 70 can include a generally planar first surface 112 opposite drive collar 78, with socket 110 extending into drive base 76 through first surface 112. The functioning of socket 110 will be described in more detail below.

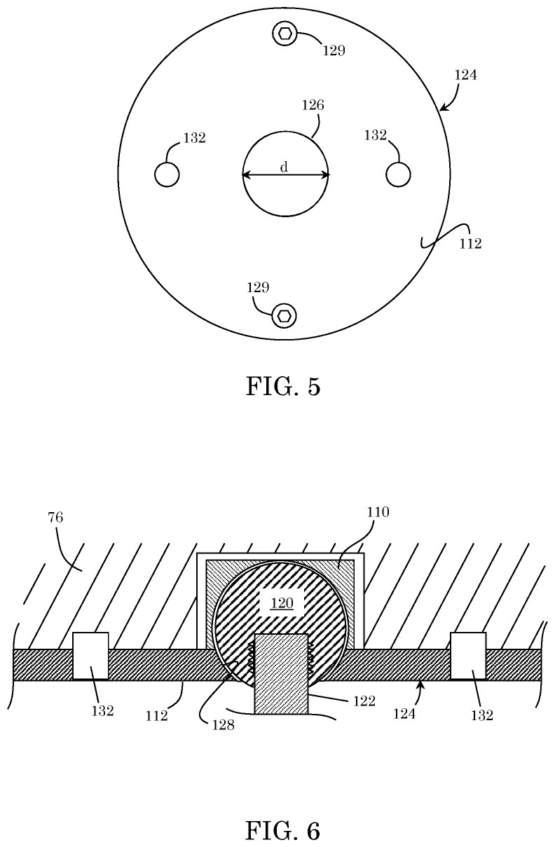

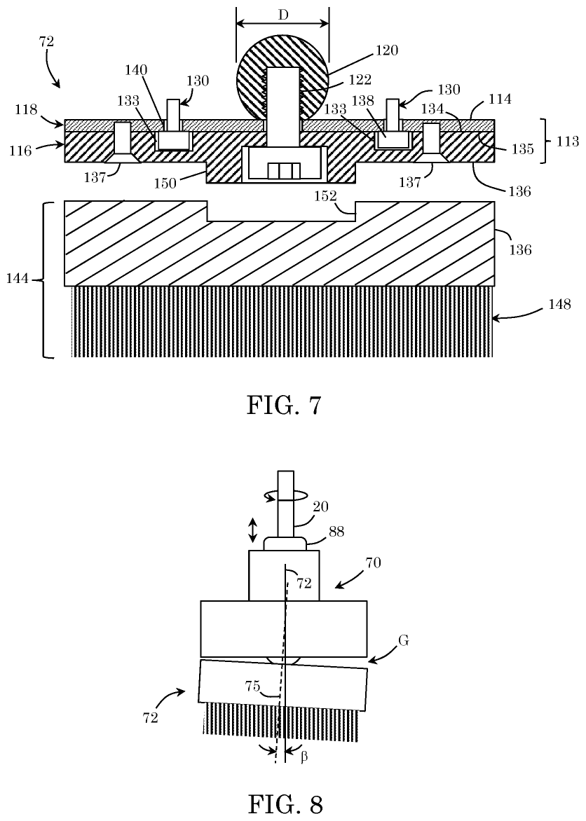

Turning to brush portion 72, brush portion 72 comprises brush base 113 defining a first surface 114 of brush portion 72. In some embodiments, brush base 113 can include a base plate 116 and a cover plate 118 attached thereto. First surface 114 of brush portion 72 can be, for example, a surface of cover plate 118. A ball 120 extends from brush portion 72. For example, ball 120 can be coupled to brush base 113 such that ball 120 extends outward from first surface 114 of brush portion 72. In some embodiments, ball 120 can be coupled to base plate 116 with a threaded bolt 122 as shown in FIGS. 3 and 7, or by a press-fit stud or pin, or by any other suitable means. Ball 120 can be rotatably engaged in socket 110, which allows brush portion 72 to move, e.g., tilt, relative to axis of rotation 74. For example, in various embodiments, brush portion 72 can rotate around axis of rotation 74. Brush portion 72 can also rotate about an axis of rotation 75 independent of axis of rotation 74 and nonparallel therewith, wherein axis of rotation 75 is a central longitudinal axis of brush portion 72. An angle between axis of rotation 74 and axis of rotation 72 is termed the tilt angle (3. Thus, ball 120 and socket 110 form a joint between drive portion 70 and brush portion 72 that allows self-levelling of brush portion 72 relative to a surface of glass sheet 22. To wit, brush portion 72 can be coupled to drive portion 70 and hang therefrom owing to gravity. Accordingly, not only can brush portion 72 orient itself to a vertical height of glass sheet 22 due to translational motion of drive collar 78 relative to shaft extension 88, but brush portion 72 can orient itself to an angular position of glass sheet 22 to ensure optimal contact between the brush portion and the glass sheet surface. A removable retaining plate 124 may be attached to drive base 76, retaining plate 124 defining an aperture 126 sized and shaped to fit a portion of ball 120 (see FIG. 5). That is, an inside surface 128 (e.g., inside edge surface) of retaining plate 124 at aperture 126 can be a circular opening with a diameter d less than a diameter D of ball 120 (see FIG. 7) to retain ball 120 in socket 110. The inside surface 128 of aperture 126 may have a radius of curvature in a direction parallel with axis of rotation 74 equal to or substantially equal to a radius of curvature of ball 120. With ball 120 engaged in socket 110 and retaining plate 124 positioned such that aperture 126 is arranged over ball 120, and with retaining plate 124 secured to drive base 76, ball 120 is captured in socket 110 but capable of rotation therein, thereby allowing brush portion 72 to tilt through a limited tilt angle β (see FIG. 8) defined at least in part by the gap G between brush portion 72 and drive portion 70. Other means of retaining ball 120 in socket 110 may be employed. For example, in some embodiments, a snap-in retaining ring (not shown) can be snapped into place in a recessed area around socket 110. Retaining plate 124 may be secured to drive base 76 by screws 129.

Brush portion 72 further comprises a plurality of torque transfer members 130 extending from brush portion 72 (e.g., first surface 114 of brush portion 72), torque transfer members 130 configured to engage with recesses 132 in drive portion 70 (e.g., drive base 76). Torque transfer members 130 transfer torque from drive portion 70 to brush portion 72. To wit, torque transfer members 130 are loosely engaged in recesses 132 and not fixed therein (see FIG. 6), allowing torque transfer members 130 to slide within recesses 132 and accommodate movement, e.g., tilt, of brush portion 72 relative to drive portion 70 while still being capable of transferring torque from drive portion 70 to brush portion 72. In some embodiments, torque transfer members 130 may be captured between cover plate 118 and base plate 116. For example, base plate 116 comprises a first surface 134 and a second surface 136 opposite first surface 134. Recesses 133 can be provided in first surface 134 of base plate 116 to accommodate heads 138 of torque transfer members 130, wherein a second surface 135 of cover plate 118 is attached to first surface 134 of base plate 116, e.g., via screws 137. Torque transfer members 130 extend through corresponding apertures 140 in cover plate 118. Apertures 140 are sized to prevent passage of the torque transfer member heads, thereby preventing the torque transfer members from being removed from recesses 132 unless cover plate 118 is removed. Cover plate 118 can be attached to base plate 116 by screws 142, thereby allowing removal of cover plate 118 should replacement of a torque transfer pin be necessary.

Brush portion 72 further comprises brush 144 including brush body 146 and a plurality of bristles 148 extending therefrom. Bristles 148 can be polymer bristles, for example nylon. Bristles 148 can be arranged in concentric rings relative to axis of rotation 74, although bristles 148 can be arranged in other suitable patterns, including a random pattern. In embodiments, brush 144 can be removably coupled to base plate 116 to allow for replacement of brush 144 in case of wear or damage to brush 144. For example, in some embodiments, brush 144 can be coupled to base plate 116 via detents (not shown), although in further embodiments, brush 144 can be coupled to base plate 116 with another suitable fastener, such as one or more screws or bolts. In some embodiments, base plate 116 can comprise a raised portion 150, for example a cylindrical raised portion, that fits within a complementary recess 152 in base plate 116.

As glass sheet 22 is conveyed through glass cleaning apparatus 10 by conveyance apparatus 12, brush heads 18 are rotated by second drive apparatus 58, wherein first drive shafts 20 are rotated about respective axes of rotation 74. Torque generated by first drive shafts 20 is transferred to respective drive portions 70 through keys 102, which causes rotation of drive portions 70. In turn, torque is applied to brush portions 72 via torque transfer members 130 of brush portion 72, whereby brush portion 72 is rotated. Variations in elevation, e.g., through warpage or other factors inherent in conveyance of glass sheet 22, are accommodated by movement of shaft extension 88 within bore 80 of drive collar 78. These same factors can be responsible for localized tilting of glass sheet 22, which is accommodated by tilting of brush portion 72 relative to drive portion 70 via the joint formed by ball 120 and socket 110, which works to keep full contact between bristles 148 and the glass sheet.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A glass cleaning apparatus, comprising:
a brush head rotatable about an axis of rotation and comprising a drive portion slidably coupled to a drive shaft, and a brush portion rotatably coupled to the drive portion.

2. The glass cleaning apparatus of claim 1, wherein the drive portion defines a bore extending along the axis of rotation.

3. The glass cleaning apparatus of claim 2, wherein the drive portion further comprises a shaft extension coupled to the drive shaft and movably captured in the bore.

4. The glass cleaning apparatus of claim 3, wherein the drive portion further comprises a key extending into the bore and slidably engaged with a keyway in the shaft extension.

5. The glass cleaning apparatus of claim 1, wherein the drive portion comprises a socket disposed therein.

6. The glass cleaning apparatus of claim 5, wherein the brush portion comprises a ball rotatably engaged in the socket.

7. The glass cleaning apparatus of claim 1, wherein brush portion comprises a torque transfer member extending therefrom, the torque transfer member spaced radially from the axis of rotation and engaged with a recess in the drive portion.

8. The glass cleaning apparatus of claim 1, wherein the glass cleaning apparatus comprises a plurality of brush heads arranged in a first row.

9. The glass cleaning apparatus of claim 8, wherein the glass cleaning apparatus comprises a second row of brush heads.

10. The glass cleaning apparatus of claim 1, wherein the brush portion comprises a brush including a plurality of bristles extending therefrom.
